(19) United States
(12) Patent Application Publication
(10) Pub. No.: US 2019/0155902 A1
(43) Pub. Date: May 23, 2019

(54) INFORMATION GENERATION METHOD, INFORMATION PROCESSING DEVICE, AND WORD EXTRACTION METHOD

(71) Applicant: FUJITSU LIMITED, Kawasaki-shi (JP)

(72) Inventors: Masahiro Kataoka, Kamakura (JP); SATOSHI MITOMA, Kawasaki (JP); KEN HAYASHIDA, Kawasaki (JP)

(73) Assignee: FUJITSU LIMITED, Kawasaki-shi (JP)

(21) Appl. No.: 16/174,402

(22) Filed: Oct. 30, 2018

(30) Foreign Application Priority Data
Nov. 22, 2017 (JP) 2017-225073

(51) Int. Cl. G06F 17/27

(52) U.S. Cl. CPC G06F 17/2755; G06F 17/2735

(57) ABSTRACT

An information processing device receives dictionary data, which is to be used in speech analysis and morphological analysis, and text data. Then, based on the dictionary data and the text data, the information processing device generates word HMM data that contains word information enabling identification of each word registered in the dictionary data, and contains co-occurrence information about the co-occurrence, with respect to each word, of the words included in the text data.

### CROSS-REFERENCE TO RELATED APPLICATION(S)

This application is based upon and claims the benefit of priority of the prior Japanese Patent Application No. 2017-225073, filed on Nov. 22, 2017, the entire contents of which are incorporated herein by reference.

### FIELD

The embodiment discussed herein is related to a computer-readable recording medium.

### BACKGROUND

Conventionally, as far as CJK characters (CJK stands for Chinese language, Japanese language, and Korean language) are concerned; morphological analysis is performed, separations among the morphemes are recognized, and character strings of splittable words are output. For example, MeCab and ChaSen represent conventional technologies for recognizing separations among the morphemes from a text and outputting character strings of splittable words. In the morphological analysis implemented in MeCab or ChaSen, a trie tree or DoubleArray is implemented, and a plurality of splittable word candidates is extracted in two paths. Then, after arriving at the end of the text, scores are calculated using a word HMM (HMM stands for Hidden Markov Model) or a CRF (which stands for Conditional Random Field); and groups of words are output that are obtained by splitting the text in the order corresponding to the scores.

Moreover, conventionally, during speech recognition, phonemes are added to a word dictionary, and a phoneme HMM and a word HMM are generated. Based on the phonemes obtained as a result of performing spectrum analysis; firstly, maximum likelihood estimation of phonemes is performed using the phoneme HMM. Subsequently, words are estimated by referring to a word dictionary in which phonemes are concatenated via an index having a tree structure. Moreover, the word HMM is used to achieve enhancement in speech recognition.

Meanwhile, a word HMM and a CRF are configured using character code strings.

International Publication Pamphlet No. 2010/100977

Japanese Laid-open Patent Publication No. 2011-227127

### SUMMARY

According to an aspect of an embodiment, an information generation method is executed by a computer. The method includes receiving dictionary data, which is to be used in common in speech analysis and morphological analysis, and text data using a processor. And the method includes generating, based on the dictionary data and the text data, co-occurring word information that contains word information enabling identification of each word registered in the dictionary data, and co-occurrence information about co-occurrence, with respect to the each word, of words included in the text data using the processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an example of the operations performed in an information processing device according to an embodiment;

FIG. 2 is a functional block diagram illustrating a configuration of the information processing device according to the embodiment;

FIG. 3 is a diagram illustrating an exemplary data structure of dictionary data;

FIG. 4A is a diagram illustrating an exemplary data structure of word HMM data (HMM stands for Hidden Markov Model);

FIG. 4B is a diagram illustrating an exemplary data structure of phoneme HMM data;

FIG. 5 is a diagram illustrating an exemplary data structure of sequence data;

FIG. 6 is a diagram illustrating an exemplary data structure of an offset table;

FIG. 7 is a diagram illustrating an exemplary data structure of an index;

FIG. 8 is a diagram illustrating an exemplary data structure of a high-order index;

FIG. 9 is a diagram for explaining hashing performed with respect to the index;

FIG. 10 is a diagram illustrating an exemplary data structure of index data;

FIG. 11 is a diagram for explaining an example of the operation for restoring a hashed index;

FIG. 12 is a diagram (1) for explaining an example of the operation for extracting words;

FIG. 13 is a diagram (2) for explaining an example of the operation for extracting words;

FIG. 14 is a diagram for explaining an example of the operation for extracting words;

FIG. 15 is a flowchart for explaining a sequence of operations performed by a word HMM generating unit;

FIG. 16A is a flowchart for explaining a sequence of operations performed by a phoneme HMM generating unit;

FIG. 16B is a flowchart for explaining a sequence of operations performed by a phoneme estimating unit;

FIG. 17 is a flowchart for explaining a sequence of operations performed by an index generating unit;

FIG. 18 is a flowchart for explaining a sequence of operations performed by a word extracting unit;

FIG. 19 is a flowchart for explaining a sequence of operations performed by a word estimating unit; and

FIG. 20 is a diagram illustrating an exemplary hardware configuration of a computer that implements the identical functions to the information processing device.

### DESCRIPTION OF EMBODIMENT

In the conventional technologies mentioned above, when speech recognition as well as morphological analysis is performed, neither it is possible to achieve standardization of the word dictionary for speech recognition and the word dictionary for morphological analysis, nor it is possible to perform extraction and maximum likelihood estimation of words with efficiency.

For example, during speech recognition, a word dictionary is used in which phonemes are concatenated using a tree structure. However, since that word dictionary has a different structure and a different format than the trie tree and DoubleArray implemented in morphological analysis, the word dictionary is not useful during morphological analysis. Hence, in order to achieve two objectives of performing speech recognition and performing morphological analysis, not only a word dictionary needs to be used in which phonemes are concatenated using a tree structure, but a morpheme dictionary having a trie tree and DoubleArray also needs to be used. Consequently, during speech recognition, it is not possible to extract words with efficiency. Moreover, in morphological analysis too, it is not possible to extract the character strings of splittable words from the text with efficiency.

Meanwhile, for example, as far as the word candidates in kanji conversion are concerned; maximum likelihood estimation is performed using a word HMM, for example. However, since a word HMM is configured using character code strings, it undergoes an increase in size when a word is added thereto. Thus, during kanji conversion, maximum likelihood estimation of words involves a cost. That is, during kanji conversion, it is not possible to perform maximum likelihood estimation of words with efficiency. Moreover, during morphological analysis too, when character strings of splittable words are extracted from a text and maximum likelihood estimation is performed, it is not possible to perform maximum likelihood estimation of words with efficiency.

Preferred embodiments of the present invention will be explained with reference to accompanying drawings. However, the invention is not limited by the embodiment described below.

### Embodiment

### Information Generation Processing According to Embodiment

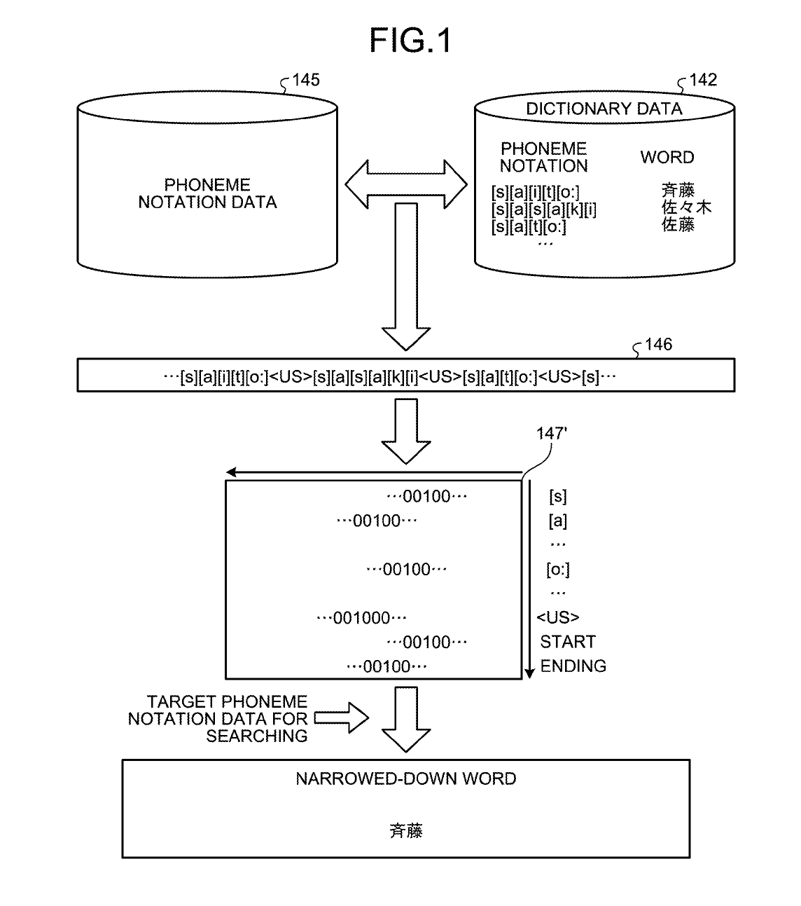

FIG. 1 is a diagram for explaining an example of an information processing device according to an embodiment. As illustrated in FIG. 1, during speech recognition, in the case of narrowing down the words from phoneme notation data to be searched, the information processing device performs the following operations. For example, it is assumed that the phoneme notation data to be searched and phoneme notation data 145 (described later) represents data written in code strings of phoneme codes. As an example, in the case of a word “ [symbol] ” (written in kanji), “[s] [a] [i] [t] [o:]” represents the phoneme notation, and each of [s], [a], [i], [t], and [o:] represents a phoneme code. Meanwhile, herein, a phoneme code is synonymous with a phoneme symbol.

The information processing device compares the phoneme notation data 145 with dictionary data 142 in which words (morphemes) are defined in a corresponding manner to phoneme notations. The dictionary data 142 is used in morphological analysis as well as in speech recognition.

The information processing device scans the phoneme notation data 145 from the start; extracts phoneme code strings matching with the phoneme notations defined in the dictionary data 142; and stores the extracted phoneme code strings in sequence data 146.

The sequence data 146 contains, from among the phoneme code strings included in the phoneme notation data, phoneme notations defined in the dictionary data 142. Meanwhile, at the separation of each phoneme notation, a <US (Unit Separator)> is registered. For example, as a result of the comparison between the phoneme notation data 145 and the dictionary data 142; if the phoneme notations “[s] [a] [i] [t] [o:]”, “[s] [a] [s] [a] [k] [i]”, and “[s] [a] [t] [o:]” that are registered in the dictionary data 142 happen to match in that order, then the information processing device generates the sequence data 146 as illustrated in FIG. 1.

After generating the sequence data 146, the information processing device generates an index 147′ corresponding to the sequence data 146. The index 147′ represents information in which phoneme codes are held in a corresponding manner to offsets. An offset indicates the position of the corresponding phoneme code in the sequence data 146. For example, when the phoneme code “s” is present at the position of the n₁-th character from the start of the sequence data 146; in that row (bitmap) in the index 147′ which corresponds to the phoneme code “s”, a flag “1” is set at the position of the offset n₁.

Moreover, in the index 147′ according to the embodiment, the positions of “start”, “end”, and <US> of a phoneme notation are also associated to offsets. For example, in the phoneme notation “[s] [a] [i] [t] [o:]”, the phoneme code “s” represents the start and the phoneme code “o:” represents the ending. When the start “s” of the phoneme notation “[s] [a] [i] [t] [o:]” is present at the position of the n₂-th character of the sequence data 146; in the row corresponding to the start of the index 147′, the flag “1” is set at the position of the offset n₂. When the ending “o:” of the phoneme notation “[s] [a] [i] [t] [o:]” is present at the position of the n₃-th character of the sequence data 146; in the row corresponding to the ending of the index 147′, the flag “1” is set at the position of the offset n₂.

Moreover, when the “<US>” is present at the position of the n₄-th character from the start of the sequence data 146; in the row corresponding to the “<US”> in the index 147′, the flag “1” is set at the position of the offset n₄.

Thus, by referring to the index 147′, the information processing device can get to know about the following information regarding each phoneme notation included in the phoneme notation data 145: the positions of the phoneme codes; the starting phoneme code; the ending phoneme code; and the separator “<US>”.

Subsequently, when the target phoneme notation data for searching is received, the information processing device can refer to the index 147′ and identify the phoneme notation included in the target phoneme notation data for searching that is received. Then, from among the words registered in the dictionary data 142, the information processing device can narrow down the words corresponding to the identified phoneme notation. In the extraction result illustrated in FIG. 1, as the narrowed-down phoneme notation, a word “ [symbol] ” (written in kanji) is extracted that corresponds to the phoneme notation “[s] [a] [i] [t] [o:]”.

As described above, based on the phoneme notation data 145 and the dictionary data 142, the information processing device generates the index 147′ related to the registered items in the dictionary data 142; and, for each registered item, sets flags enabling identification of the start and the ending of that registered item. Then, by referring to the index 147′, the information processing device identifies the phoneme notation included in the target phoneme notation data for searching; and extracts the words corresponding to the identified phoneme notation from among the words registered in the dictionary data 142.

Meanwhile, the explanation given above is not limited to speech recognition. That is, during morphological analysis too, the phoneme notation data 145 can be substituted with character string data. Then, based on the character string data and the dictionary data 142, the information processing device can generate the index 147′ related to the registered items in the dictionary data 142; and, for each registered item, can set flags enabling identification of the start and the ending of that registered item. Then, by referring to the index 147′, with character strings from the start to the ending serving as units for separation, the information processing device can determine the longest-matching character string and extract the splittable words from the character string data.

The following explanation is given for the case of performing speech recognition.

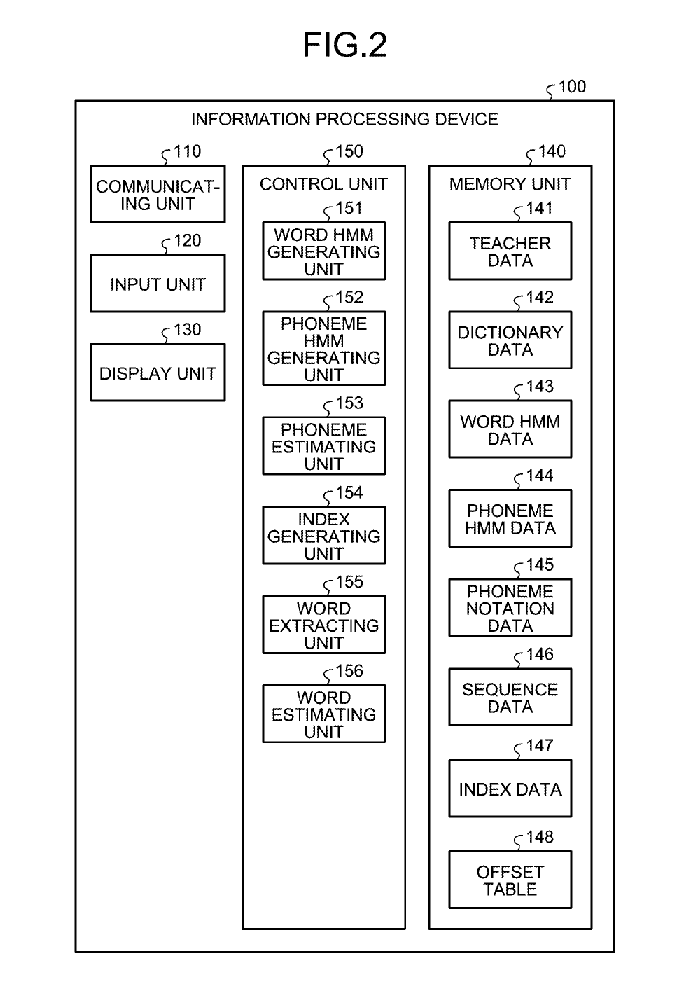

FIG. 2 is a functional block diagram illustrating a configuration of the information processing device according to the embodiment. As illustrated in FIG. 2, an information processing device 100 includes a communicating unit 110, an input unit 120, a display unit 130, a memory unit 140, and a control unit 150.

The communicating unit 110 is a processing unit that performs communication with other external devices via a network. The communicating unit 110 corresponds to a communication device. For example, the communicating unit 110 can receive teacher data 141, the dictionary data 142, and the phoneme notation data 145 from an external device; and can store the received data in the memory unit 140.

The input unit 120 is an input device meant for inputting a variety of information to the information processing device 100. Examples of the input unit 120 include a keyboard, a mouse, and a touch-sensitive panel.

The display unit 130 is a display device that displays a variety of information output from the control unit 150. Examples of the display unit 130 include a liquid crystal display and a touch-sensitive panel.

The memory unit 140 is used to store the teacher data 141, the dictionary data 142, word HMM data 143, phoneme HMM data 144, the phoneme notation data 145, the sequence data 146, index data 147, and an offset table 148. Examples of the memory unit 140 include a semiconductor memory such as a flash memory, and a memory device such as a hard disk drive (HDD).

The teacher data 141 contains homophones, and represents data indicating a large volume of natural sentences. For example, the teacher data 141 can be a corpus representing data of a large volume of natural sentences.

The dictionary data 142 represents information for defining phoneme notations and words representing splittable candidates (candidates for splitting).

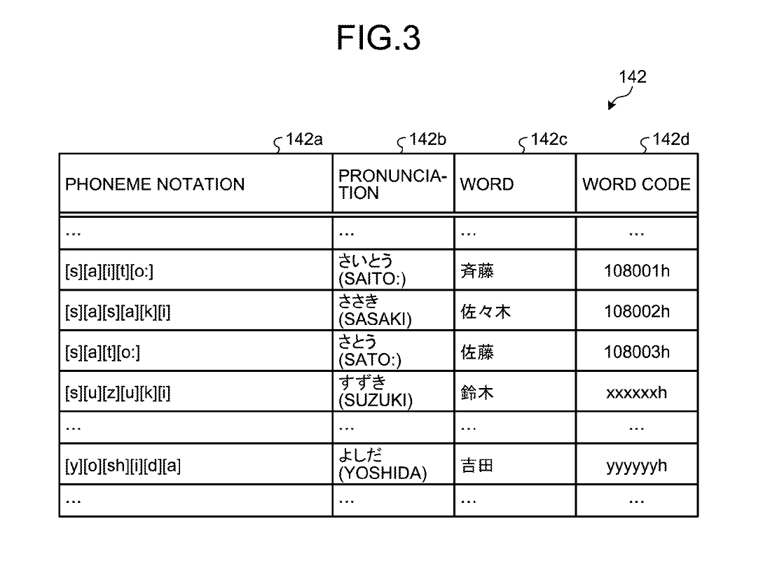

FIG. 3 is a diagram illustrating an exemplary data structure of the dictionary data. As illustrated in FIG. 3, in the dictionary data 142, the following items are held in a corresponding manner: phoneme notation 142a, pronunciation 142b, word 142c, and word code 142d. Each entry in the phoneme notation 142a indicates the phoneme code string corresponding to an entry in the word 142c. Herein, a phoneme code string is synonymous to a phonetic symbol string. Each entry in the pronunciation 142b represents the pronunciation, written in hiragana, of an entry in the word 142c. The entries in the word code 142d are different than the character code strings in the word 142c, and imply encoded codes that uniquely represent words. For example, the entries in the word code 142d indicate codes that are assigned to be shorter in length with respect to the words having a high frequency of appearance from among the words appearing in the data of the document. Meanwhile, the dictionary data 142 is generated in advance.

Returning to the explanation with reference to FIG. 2, the word HMM data 143 contains word codes enabling identification of the words registered in the dictionary data 142; and contains co-occurrence information about co-occurrence, with respect to each word, of the words included in the teacher data 141. For example, the co-occurrence contains co-occurring words and co-occurrence rates. Herein, co-occurrence implies, for example, back-to-back appearance of a particular word included in the teacher data 141 and some other word. Moreover, the co-occurrence rate implies, for example, the probability of back-to-back appearance of a particular word included in the teacher data 141 and some other word.

The phoneme HMM data 144 contains phoneme codes and co-occurrence information of the phoneme codes. The co-occurrence information contains, for example, co-occurring phoneme codes and co-occurrence rates. Herein, co-occurrence implies, for example, back-to-back appearance of a particular phoneme code included in the phoneme data and some other phoneme code. Moreover, the co-occurrence rate implies, for example, the probability of back-to-back appearance of a particular phoneme code included in the phoneme data and some other phoneme code.

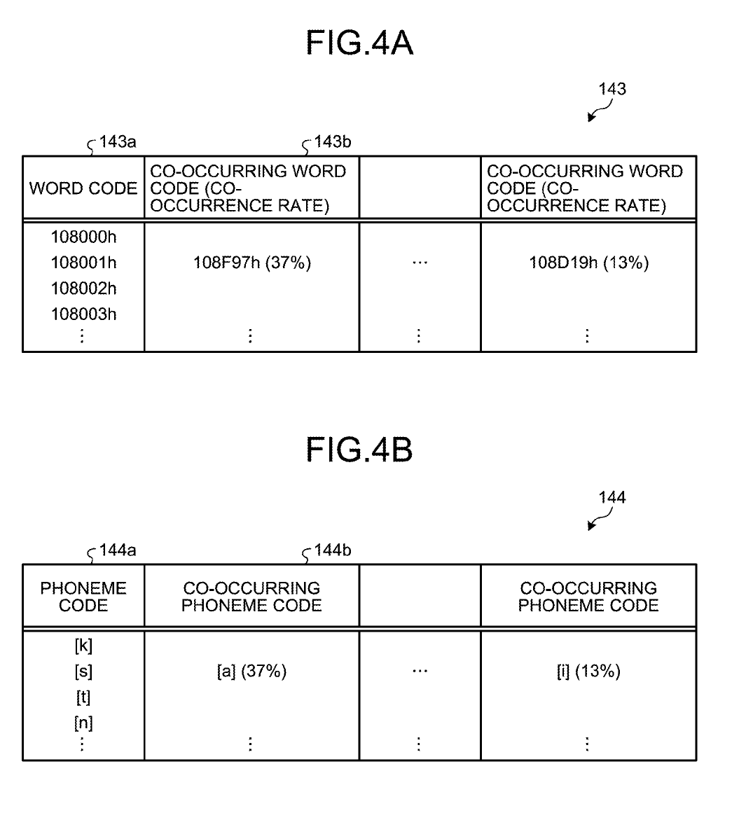

FIG. 4A is a diagram illustrating an exemplary data structure of the word HMM data. As illustrated in FIG. 4A, the word HMM data 143 contains the following items: word code 143a and co-occurring word code 143b. The word code 143a corresponds to the word code 142d of the dictionary data 142. Each entry in the co-occurring word code 143b implies the word code corresponding to a word that co-occurs with a word specified in the word code 143a. Meanwhile, each number written in brackets represents the co-occurrence rate. As an example, the word corresponding to a word code “108001h” specified in the word code 143a co-occurs, in the teacher data 141, at the probability of 37% with the word corresponding to a word code “108F97h” specified in the co-occurring word code 143b. Moreover, the word corresponding to the word code “108001h” specified in the word code 143a co-occurs, in the teacher data 141, at the probability of 13% also with the word corresponding to a word code “108D19h” specified in the co-occurring word code 143b. Meanwhile, the word HMM data 143 is generated by a word HMM generating unit 151 (described later).

FIG. 4B is a diagram illustrating an exemplary data structure of phoneme HMM data. As illustrated in FIG. 4B, in the phoneme HMM data 144, the following items are held in a corresponding manner: phoneme code 144a and co-occurring phoneme code 144b. The phoneme code 144a corresponds to phoneme codes. The co-occurring phoneme code 144b corresponds to phoneme codes that co-occur with the phoneme codes specified in the phoneme code 144a. Meanwhile, each number written in brackets represents the co-occurrence rate. As an example, the phoneme code “s” specified in the phoneme code 144a co-occurs at the probability of 37% with the phoneme code “a” specified in the co-occurring phoneme code 144b. Moreover, the phoneme code “s” specified in the phoneme code 144a co-occurs at the probability of 13% also with the phoneme code “i” specified in the co-occurring phoneme code 144b. Meanwhile, the phoneme HMM data 144 generated by a phoneme HMM generating unit 152 (described later).

The phoneme notation data 145 represents the data of the target phoneme code string for processing. In other words, the phoneme notation data 145 represents the data of a phonetic symbol string that is obtained as a result of pronouncing the processing target. As an example, in the phoneme notation data 145, the following phoneme notation is written: “ . . . [s] [a] [i] [t] [o:] [s] [a] [n] [t] [o] [s] [a] [s] [a] [k] [i] [s] [a] [n] [t] [o] [s] [a] [t] [o:] [s] [a] [n] [g] [a] . . . ” ( . . . Saito: san to Sasaki san to Sato: san ga . . . (in Japanese language)). Herein, in the brackets, the concerned Japanese character string is written using Roman characters.

Returning to the explanation with reference to FIG. 2, the sequence data 146 contains the phoneme notations defined in the dictionary data 142 from among the phoneme code string included in the phoneme notation data 145. In the case performing speech recognition, the sequence data 146 contains the phoneme notations included in the phoneme notation data 145. However, in the case of performing morphological analysis, it is assumed that the sequence data 146 contains the words included in the character string data that is substituted for the phoneme notation data 145.

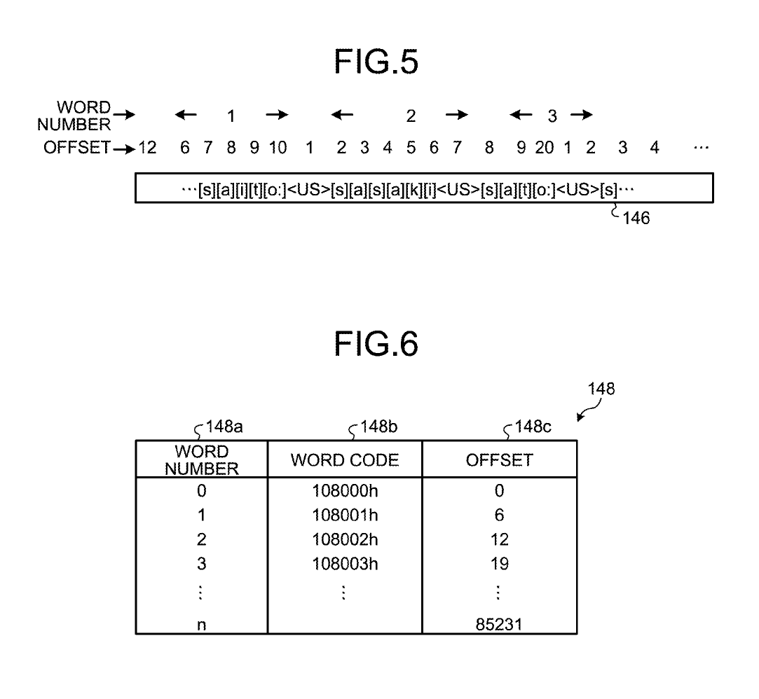

FIG. 5 is a diagram illustrating an exemplary data structure of the sequence data. As illustrated in FIG. 5, in the sequence data 146, the phoneme notations are separated using the <US>. The numbers illustrated above the sequence data represent the offsets from the start “0” of the sequence data 146. Moreover, the numbers illustrated above the offsets represent word numbers that are sequentially assigned to the words starting from the word indicated by the initial phoneme notation of the sequence data 146.

Returning to the explanation with reference to FIG. 2, the index data 147 represents the data obtained by performing hashing with respect to the index 147′ as described later. The index 147′ represents information in which phoneme codes are associated to offsets. An offset indicates the position of the corresponding phoneme code in the sequence data 146. For example, when the phoneme code “s” is present at the position of the n₁-th character from the start of the sequence data 146; in that row (bitmap) in the index 147′ which corresponds to the phoneme code “s”, the flag “1” is set at the position of the offset n₁.

Moreover, in the index 147′, the positions of “start”, “ending”, and <US> are also associated to offsets. For example, in the phoneme notation “[s] [a] [i] [t] [o:]”, the phoneme code “s” represents the start and the phoneme code “o:” represents the ending. When the start “s” of the phoneme notation “[s] [a] [i] [t] [o:]” is present at the position of the n₂-th character of the sequence data 146; in the row corresponding to the start of the index 147′, the flag “1” is set at the position of the offset n₂. When the ending “o:” of the phoneme notation “[s] [a] [i] [t] [o:]” is present at the position of the n₃-th character of the sequence data 146; in the row corresponding to the ending of the index 147′, the flag “1” is set at the position of the offset n₃. When the “<US>” is present at the position of the n₄-th character from the start of the sequence data 146; in the row corresponding to the “<US>” in the index 147′, the flag “1” is set at the position of the offset n₄.

The index 147′ is subjected to hashing as described later, and the result is stored as the index data 147 in the memory unit 140. Meanwhile, the index data 147 is generated by an index generating unit 154 (described later).

Returning to the explanation with reference to FIG. 2, the offset table 148 is a table for storing the initial bitmap of the index data 147 and the offset corresponding to the start of each word in the sequence data 146 and the dictionary data 142. The offset table 148 is generated at the time of restoring the index data 147.

FIG. 6 is a diagram illustrating an exemplary data structure of the offset table. As illustrated in FIG. 6, in the offset table 148, the following items are stored in a corresponding manner: word number 148a, word code 148b, and offset 148c. The entries in the word number 148a represent numbers to which the words indicated by each initial phoneme notation of the sequence data 146 are sequentially assigned from the start. Herein, the entries in the word number 148a are indicated by numbers assigned in ascending order starting from “0”. The word code 148b corresponds to the word code 142d of the dictionary data 142. Each entry in the offset 148c indicates the position (offset) of the “start” of a phoneme notation from the start of the sequence data 146. For example, if the phoneme notation “[s] [a] [i] [t] [o:]” corresponding to the word code “108001h” is present at the position of the first word from the start of the sequence data 146, then “1” is set as the corresponding word number. Moreover, of the phoneme notation “[s] [a] [i] [t] [o:]” corresponding to the word code “108001h”, if the initial phoneme code “s” is present at the position of the sixth character from the start of the sequence data 146, then “6” is set as the corresponding offset.

Returning to the explanation with reference to FIG. 2, the control unit 150 includes the word HMM generating unit 151, the phoneme HMM generating unit 152, a phoneme estimating unit 153, the index generating unit 154, a word extracting unit 155, and a word estimating unit 156. The control unit 150 can be implemented using a central processing unit (CPU) or a micro processing unit (MPU). Alternatively, the control unit 150 can be implemented using hardware wired logic such as an application specific integrated circuit (ASIC) or a field programmable gate array (FPGA).

The word HMM generating unit 151 generates the word HMM data 143 based on the dictionary data 142, which is used in morphological analysis, and the teacher data 141.

For example, based on the dictionary data 142, the word HMM generating unit 151 encodes the words included in the teacher data 141. Then, the word HMM generating unit 151 sequentially selects the words included in the teacher data 141. Subsequently, with respect to the selected word, the word HMM generating unit 151 calculates the co-occurrence rate of the other words included in the teacher data 141. Then, the word HMM generating unit 151 stores, in the word HMM data 143, the word code of the selected word in a corresponding manner to the word codes of the other words and the respective co-occurrence rates. The word HMM generating unit 151 repeatedly performs the operations described above and generates the word HMM data 143. Meanwhile, herein, a word can be a CJK word or can be an English word.

The phoneme HMM generating unit 152 generates the phoneme HMM data 144 based on the phoneme data. For example, the phoneme HMM generating unit 152 sequentially selects a phoneme code from a plurality of phoneme codes based on the phoneme data. Then, with respect to the selected phoneme code, the phoneme HMM generating unit 152 calculates the co-occurrence rate of the other phoneme codes included in the phoneme data. Subsequently, the phoneme HMM generating unit 152 stores the selected phoneme code in a corresponding manner to the other phoneme codes and the respective co-occurrence rates in the phoneme HMM data 144. The phoneme HMM generating unit 152 repeatedly performs the operations described above and generates the phoneme HMM data 144.

The phoneme estimating unit 153 estimates phoneme codes from phoneme signals. For example, the phoneme estimating unit 153 performs Fourier transformation with respect to the phoneme data, performs spectrum analysis, and extracts the speech features. Then, the phoneme estimating unit 153 estimates the phoneme codes based on the speech features. Moreover, the phoneme estimating unit 153 confirms the estimated phoneme codes using the phoneme HMM data 144. That is done with the aim of achieving enhancement in the accuracy of the estimated phoneme codes. Meanwhile, the phoneme data can be the target phoneme notation data for searching.

The index generating unit 154 generates the index data 147 based on the dictionary data 142 to be used in morphological analysis. The index data 147 indicates the relative positions of the phoneme codes that include: the phoneme codes included in the phoneme notation of each word registered in the dictionary data 142, the initial phoneme code of the phoneme notation, and the last phoneme code of the phoneme notation.

For example, the index generating unit 154 compares the phoneme notation data 145 with the dictionary data 142. The index generating unit 154 scans the phoneme notation data 145 from the start, and extracts a phoneme code string matching with an entry in the phoneme notation 142a registered in the dictionary data 142. The index generating unit 154 stores the matched phoneme code string in the sequence data 146. At the time of storing the next matching phoneme code sting in the sequence data 146, the index generating unit 154 sets the <US> after the previous character string, and then stores the next matching phoneme code string after the <US>. The index generating unit 154 repeatedly performs the operations described above, and generates the sequence data 146.

Moreover, after generating the sequence data 146, the index generating unit 154 generates the index 147′. The index generating unit 154 scans the sequence data 146, and generates the index 147′ in which the phoneme codes, the start of the phoneme code string, the ending of the phoneme code string, and the <US> are associated to offsets.

Furthermore, the index generating unit 154 associates the start of the phoneme code string with a word number, and generates a high-order index corresponding to the start of the phoneme code string. As a result, the index generating unit 154 generates a high-order index according to the granularity of the word numbers, thereby enabling achieving enhancement in the speed of narrowing down the extraction area at the time of subsequent extraction of keywords.

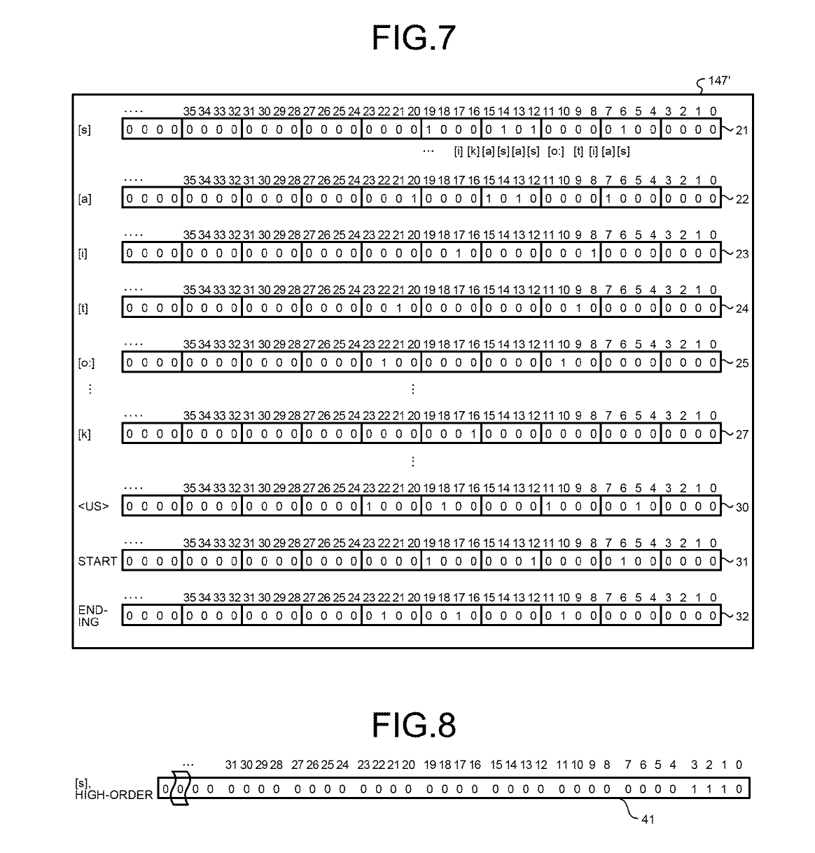

FIG. 7 is a diagram illustrating an exemplary data structure of the index. FIG. 8 is a diagram illustrating an exemplary data structure of the high-order index. As illustrated in FIG. 7, the index 147′ includes bitmaps 21 to 32 corresponding to the phoneme codes, the <US>, the start, and the ending.

For example, of the sequence data “ . . . [s] [a] [i] [t] [o:] <US> . . . ”, regarding the phoneme codes [s] [a] [i] [t] [o:] . . . , bitmaps 21 to 25 are set as the corresponding bitmaps. Meanwhile, in FIG. 7, the bitmaps corresponding to other phoneme codes are not illustrated.

The bitmap corresponding to the <US> is set as a bitmap 30. The bitmap corresponding to the “start” of phoneme notations is set as a bitmap 31. The bitmap corresponding to the “ending” of phoneme notations is set as a bitmap 32.

For example, in the sequence data 146 illustrated in FIG. 5, the phoneme code “s” is present at the offsets 6, 12, 14, and 19 of the sequence data 146. Hence, the index generating unit 154 sets the flag “1” at the offsets 6, 12, 14, and 19 in the bitmap 21 of the index 147′ illustrated in FIG. 7. Regarding the other phoneme codes and the <US>too, the index generating unit 154 sets the flags in an identical manner.

Moreover, in the sequence data 146 illustrated in FIG. 5, the start of the phoneme notations are present at the offsets 6, 12, and 19 of the sequence data 146. Hence, the index generating unit 154 sets the flag “1” at the offsets 6, 12, and 19 in the bitmap 31 of the index 147′ illustrated in FIG. 7.

Furthermore, in the sequence data 146 illustrated in FIG. 5, the ending of the phoneme notations is present at the offsets 10, 17, and 22 of the sequence data 146. Hence, the index generating unit 154 sets the flag “1” at the offsets 10, 17, and 22 in the bitmap 32 of the index 147′ illustrated in FIG. 7.

As illustrated in FIG. 8, the index 147′ includes a high-order bitmap corresponding to the initial phoneme code of the phoneme notations. For example, corresponding to the initial phoneme codes “s”, a high-order bitmap 41 is set. In the sequence data 146 illustrated in FIG. 5, the start “s” of the phoneme notations is present at the word numbers “1”, “2”, and “3” of the sequence data 146. Hence, the index generating unit 154 sets the flag “1” at the word numbers “1”, “2”, and “3” in the high-order bitmap 41 of the index 147′ illustrated in FIG. 8.

After generating the index 147′, the index generating unit 154 performs hashing with respect to the index 147′ with the aim of reducing the volume of data in the index 147′, and generates the index data 147.

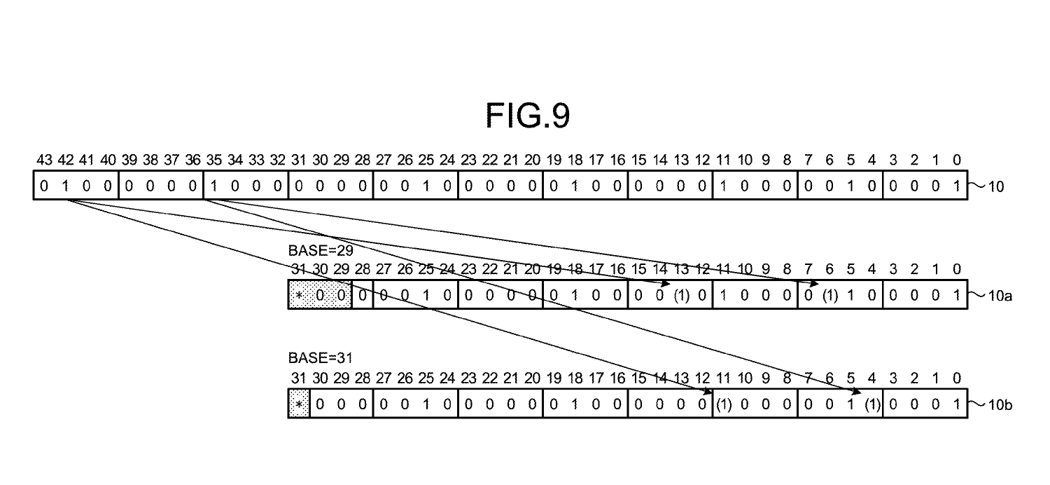

FIG. 9 is a diagram for explaining hashing performed with respect to the index. Herein, it is assumed that a bitmap 10 is included in the index, and the explanation is given about the case of performing hashing with respect to the bitmap 10.

For example, from the bitmap 10, the index generating unit 154 generates a bitmap 10a corresponding to a base 29 and a bitmap 10b corresponding to a base 31. As against the bitmap 10, the bitmap 10a has a partition set after each offset “29”, and the offsets that have the flag “1” set therein and that are positioned after the set partition are expressed using the flags of the offset “0” to the offset “28” of the bitmap 10a.

The index generating unit 154 copies the information from the offset “0” to the offset “28” of the bitmap 10 in the bitmap 10a. Moreover, the index generating unit 154 processes the information of the offsets from the offset “29” onward of the bitmap 10a in the following manner.

The offset “35” of the bitmap 10 has the flag “1” set therein. Since the offset “35” is equal to the offset “29+6”, the index generating unit 154 sets the flag “(1)” in the offset “6” of the bitmap 10a. Meanwhile, the first offset is set to “0”. The offset “42” of the bitmap 10 has the flag “1” set therein. Since the offset “42” is equal to the offset “29+13”, the index generating unit 154 sets the flag “(1)” in the offset “13” of the bitmap 10a.

As against the bitmap 10, the bitmap 10b has a partition set at each offset “31”, and the offsets that have the flag “1” set therein and that are positioned after the set partition are expressed using the flags of the offset “0” to the offset “30” of the bitmap 10b.

The offset “35” of the bitmap 10 has the flag “1” set therein. Since the offset “35” is equal to the offset “31+4”, the index generating unit 154 sets the flag “(1)” in the offset “4” of the bitmap 10b. Meanwhile, the first offset is set to “0”. The offset “42” of the bitmap 10 has the flag “1” set therein. Since the offset “42” is equal to the offset “31+11”, the index generating unit 154 sets the flag “(1)” in the offset “11” of the bitmap 10b.

As a result of performing the operations explained above, the index generating unit 154 generates the bitmaps 10a and 10b from the bitmap 10. Thus, the bitmaps 10a and 10b represent the result of hashing performed with respect to the bitmap 10.

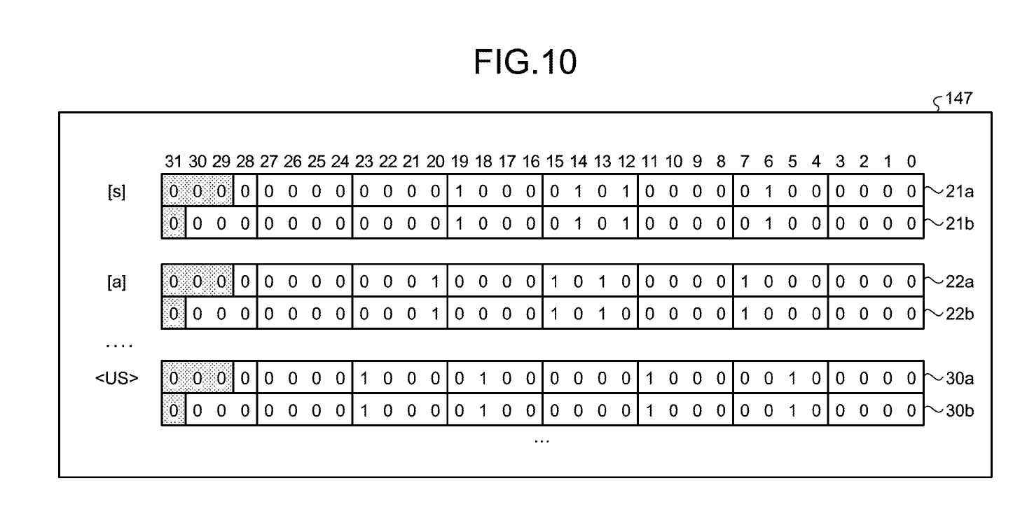

As a result of performing the hashing with respect to the bitmaps 21 to 32 illustrated in FIG. 7, the index generating unit 154 generates the post-hashing index data 147. FIG. 10 is a diagram illustrating an exemplary data structure of the index data. For example, when hashing is performing with respect to the bitmap 21 of the pre-hashing index 147′ illustrated in FIG. 7, bitmaps 21a and 21b are generated as illustrated in FIG. 10. Similarly, when hashing is performing with respect to a bitmap 22 of the pre-hashing index 147′ illustrated in FIG. 7, bitmaps 22a and 22b are generated as illustrated in FIG. 10. Moreover, when hashing is performing with respect to the bitmap 30 of the pre-hashing index 147′ illustrated in FIG. 7, bitmaps 30a and 30b are generated as illustrated in FIG. 10. Meanwhile, in FIG. 10, the other hashed bitmaps are not illustrated.

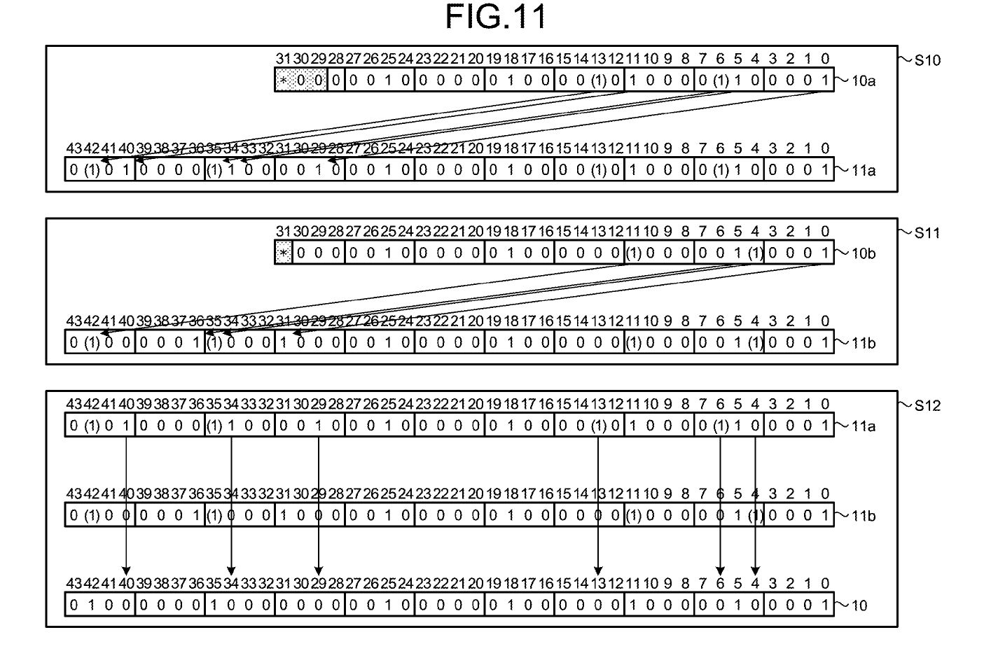

The following explanation is given about the restoration of hashed bitmaps. FIG. 11 is a diagram for explaining an example of the operation for restoring a hashed index. Herein, as an example, the explanation is given about the operation of restoring the bitmap 10 based on the bitmaps 10a and 10b. The bitmaps 10, 10a, and 10b are same as explained earlier with reference to FIG. 9.

The following explanation is given about the operation performed at Step S10. In the restoration operation, a bitmap 11a is generated based on the bitmap 10a corresponding to the base 29. The information about the flags of the offset “0” to the offset “28” in the bitmap 11a is identical to the information about the flags of the offset “0” to the offset “28” in the bitmap 10a. Moreover, the flag information of the offset “29” onward in the bitmap 11a represents the repetition of the information about the offset “0” to the offset “28” in the bitmap 10a.

The following explanation is given about the operation performed at Step S11. In the restoration operation, a bitmap 11b is generated based on the bitmap 10b corresponding to the base 31. The information about the flags of the offset “0” to the offset “30” in the bitmap 11b is identical to the information about the flags of the offset “0” to the offset “30” in the bitmap 10b. Moreover, the flag information of the offset “31” onward in the bitmap 11b represents the repetition of the information about the offset “0” to the offset “30” in the bitmap 10b.

The following explanation is given about the operation performed at Step S12. In the restoration operation, the bitmap 10 is generated by performing the AND operation of the bitmaps 11a and 11b. In the example illustrated in FIG. 11, in the offsets “0”, “5”, “11”, “18”, “25”, “35”, and “42”; the flag is set to “1” in the bitmaps 11a and 11b. Hence, in the bitmap 10, the flag of the offsets “0”, “5”, “11”, “18”, “25”, “35”, and “42” becomes equal to “1”. This bitmap 10 represents the restored bitmap. In the restoration operation, the identical operations are performed also with respect to the other bitmaps so that those bitmaps are restored, and the index 147′ is generated.

Returning to the explanation with reference to FIG. 2, the word extracting unit 155 is a processing unit that generates the index 147′ based on the index data 147; identifies, based on the index 147′, the phoneme notations included in the target phoneme notation data for searching; and extracts words corresponding to the identified phoneme notations.

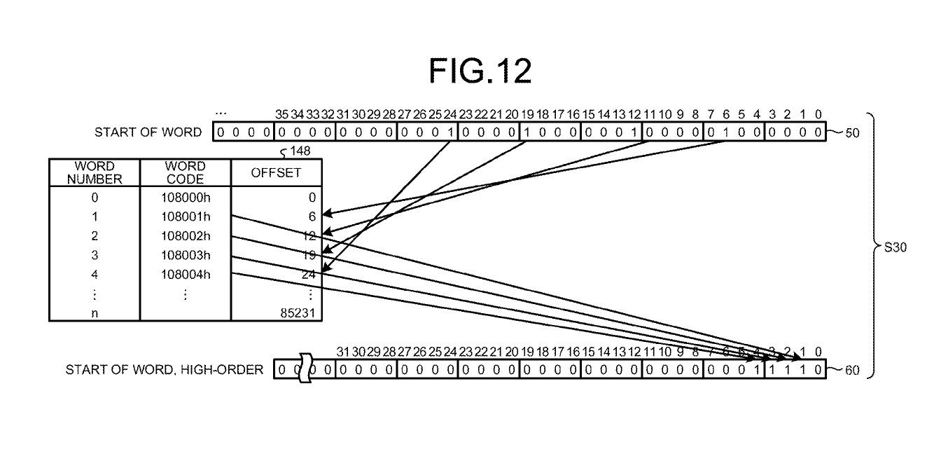

FIGS. 12 to 14 are diagrams for explaining an example of the operation for extracting words. In the example illustrated in FIGS. 12 to 14, the phoneme notation “[s] [a] [i] [t] [o:]” is included in the target phoneme notation data for searching. Moreover, starting from the first phoneme code in the target phoneme data for searching, the bitmaps of the phoneme codes are sequentially read from the index data 147, and the following operations are performed.

Firstly, the word extracting unit 155 reads the initial bitmap from the index data 147 and restores it. The restoration operation is same as the earlier explanation with reference to FIG. 11. Hence, the explanation is not given again. Then, the word extracting unit 155 generates the offset table 148 using the restored initial bitmap, the sequence data 146, and the dictionary data 142.

The following explanation is given about the operation performed at Step S30. For example, the word extracting unit 155 identifies the offsets having “1” set therein in a restored initial bitmap 50. As an example, if “1” is set in the offset “6”, then the word extracting unit 155 refers to the sequence data 146 and identifies the phoneme notation and the word number corresponding to the offset “6”; and refers to the dictionary data 142 and extracts the word code of the identified phoneme notation. Then, the word extracting unit 155 adds the word number, the word code, and the offset in a corresponding manner in the offset table 148. The word extracting unit 155 repeatedly performs the operations described above, and generates the offset table 148.

Subsequently, the word extracting unit 155 generates an initial high-order bitmap 60 according to the granularity of the words. The reason for generating the initial high-order bitmap 60 according to the granularity of the words is to limit the number of processing targets and to achieve enhancement in the search speed. Herein, the granularity of the words is set to be the 64-bit section from the start of the sequence data 146. The word extracting unit 155 refers to the offset table 148; identifies the word numbers having the offsets included in the 64-bit section; and sets the flag “1” corresponding to the identified word numbers in the initial high-order bitmap 60. Herein, assume that the offsets “0”, “6”, “12”, “19”, and “24” are included in the 64-bit section. In that case, the word extracting unit 155 sets the flag “1” corresponding to the word numbers “1”, “2”, “3”, and “4” in the initial high-order bitmap 60.

The following explanation is given about the operation performed at Step S31. The word extracting unit 155 identifies the word numbers corresponding to the flags “1” set in the initial high-order bitmap 60; and identifies the offsets corresponding to the identified word numbers by referring to the offset table 148. In the high-order bitmap 60, the flag “1” is set corresponding to the word number “1”, thereby indicating that the offset corresponding to the word number “1” is “6”.

The following explanation is given about the operation performed at Step S32. The word extracting unit 155 reads, from the index data 147, the bitmap of the first phoneme code “s” and the initial bitmap of the target phoneme notation data for searching. Regarding the initial bitmap that is read, the word extracting unit 155 restores the area near the offset “6” and sets the restoration result as a bitmap 81. Regarding the bitmap of the phoneme code “s” that is read, the word extracting unit 155 restores the area near the offset “6” and sets the restoration result as a bitmap 70. As an example, only the area of the bits “0” to “29” of the base portion including the offset “6” is restored.

The word extracting unit 155 performs the AND operation of the initial bitmap 81 and the bitmap 70 of the phoneme code “s”, and identifies the start position of the phoneme notation. The result of the AND operation of the initial bitmap 81 and the bitmap 70 of the phoneme code “s” is referred to as a bitmap 70A. In the bitmap 70A, the flag “1” is set in the offset “6”, thereby indicating that the offset “6” represents the start of the phoneme notation.

The word extracting unit 155 corrects a high-order bitmap 61 corresponding to the start and the phoneme code “s”. In the high-order bitmap 61, since the result of “1” is obtained from the AND operation of the initial bitmap 81 and the bitmap 70 corresponding to the phoneme code “s”, the flag “1” is set corresponding to the word number “1”.

The following explanation is given about the operation performed at Step S33. The word extracting unit shifts the bitmap 70A, which corresponds to the start and the phoneme code “s”, to the left-hand side by one bit, and generates a bitmap 70B. Then, the word extracting unit 155 reads, from the index data 147, the bitmap of the second phoneme code “a” of the target phoneme notation data for searching. Regarding the bitmap of the phoneme code “a” that is read, the word extracting unit 155 restores the area near the offset “6” and sets the restoration result as a bitmap 71. As an example, only the area of the bits “0” to “29” of the base portion including the offset “6” is restored.

The word extracting unit 155 performs the AND operation of the bitmap 70B of the initial phoneme code “s” and the bitmap 71 of the phoneme code “a”, and determines whether the phoneme code string “s” “a” is present at the start corresponding to the word number “1”. The result of the AND operation of the bitmap 70B of the initial phoneme code “s” and the bitmap 71 of the phoneme code “a” is referred to as a bitmap 70C. In the bitmap 70C, the flag “1” is set in the offset “7”, thereby indicating that the phoneme code string “s” “a” is present at the start corresponding to the word number “1”.

The word extracting unit 155 corrects a high-order bitmap 62 corresponding to the start and the phoneme code string “s” “a”. In the high-order bitmap 62, since the result of “1” is obtained from the AND operation of the bitmap 70B corresponding to the start and the phoneme code “s” and the bitmap 71 corresponding to the phoneme code “a”, the flag “1” is set corresponding to the word number “1”.

The following explanation is given about the operation performed at Step S34. The word extracting unit 155 shifts the bitmap 70C, which corresponds to the start and the phoneme code string “s” “a”, to the left-hand side by one bit, and generates a bitmap 70D. The word extracting unit 155 reads, from the index data 147, the bitmap of the third phoneme code “i” of the target phoneme notation data for searching. Regarding the bitmap of the phoneme code “i” that is read, the word extracting unit 155 restores the area near the offset “6” and sets the restoration result as a bitmap 72. As an example, only the area of the bits “0” to “29” of the base portion including the offset “6” is restored.

The word extracting unit 155 performs the AND operation of the bitmap 70D corresponding to the start and the phoneme code string “s” “a” and the bitmap 72 of the phoneme code “i”, and determines whether the phoneme code string “s” “a” “i” is present at the start corresponding to the word number “1”. The result of the AND operation of the bitmap 70D corresponding to the start and the phoneme code string “s” “a” and the bitmap 72 corresponding to the phoneme code “i” is referred to as a bitmap 70E. In the bitmap 70E, the flag “1” is set in the offset “8”, thereby indicating that the phoneme code string “s” “a” “i” is present at the start corresponding to the word number “1”.

The word extracting unit 155 corrects a high-order bitmap 63 corresponding to the start and the phoneme code string “s” “a” “i”. In the high-order bitmap 63, since the result of “1” is obtained from the AND operation of the bitmap 70D corresponding to the start and the phoneme code string “s” “a” “i” and the bitmap 72 corresponding to the phoneme code “i”, the flag “1” is set corresponding to the word number “1”.

The following explanation is given about the operation performed at Step S35. The word extracting unit 155 shifts the bitmap 70E, which corresponds to the start and the phoneme code string “s” “a” “i”, to the left-hand side by one bit, and generates a bitmap 70F. The word extracting unit 155 reads, from the index data 147, the bitmap of the fourth phoneme code “t” of the target phoneme notation data for searching. Regarding the bitmap of the phoneme code “t” that is read, the word extracting unit 155 restores the area near the offset “6” and sets the restoration result as a bitmap 73. As an example, only the area of the bits “0” to “29” of the base portion including the offset “6” is restored.

The word extracting unit 155 performs the AND operation of the bitmap 70F corresponding to the start and the phoneme code string “s” “a” “i” and the bitmap 73 corresponding to the phoneme code “t”, and determines whether the phoneme code string “s” “a” “i” “t” is present at the start corresponding to the word number “1”. The result of the AND operation of the bitmap 70F corresponding to the start and the phoneme code string “s” “a” “i” and the bitmap 73 corresponding to the phoneme code “t” is referred to as a bitmap 70G. In the bitmap 70G, the flag “1” is set in the offset “9”, thereby indicating that the phoneme code string “s” “a” “i” “t” is present at the start corresponding to the word number “1”.

The word extracting unit 155 corrects a high-order bitmap 64 corresponding to the start and the phoneme code string “s” “a” “i” “t”. In the high-order bitmap 64, since the result of “1” is obtained from the AND operation of the bitmap 70F corresponding to the start and the phoneme code string “s” “a” “i” and the bitmap 73 corresponding to the phoneme code “t”, the flag “1” is set corresponding to the word number “1”.

The following explanation is given about the operation performed at Step S36. The word extracting unit 155 shifts the bitmap 70G, which corresponds to the start and the phoneme code string “s” “a” “i” “t”, to the left-hand side by one bit, and generates a bitmap 70H. The word extracting unit 155 reads, from the index data 147, the bitmap of the fifth phoneme code “o:” of the target phoneme notation data for searching. Regarding the bitmap of the phoneme code “o:” that is read, the word extracting unit 155 restores the area near the offset “6” and sets the restoration result as a bitmap 74. As an example, only the area of the bits “0” to “29” of the base portion including the offset “6” is restored.

The word extracting unit 155 performs the AND operation of the bitmap 70H corresponding to the start and the phoneme code string “s” “a” “i” “t” and the bitmap 74 corresponding to the phoneme code “o:”, and determines whether the phoneme code string “s” “a” “i” “t” “o:” is present at the start corresponding to the word number “1”. The result of the AND operation of the bitmap 70H corresponding to the start and the phoneme code string “s” “a” “i” “t” and the bitmap 74 corresponding to the phoneme code “o:” is referred to as a bitmap 701. In the bitmap 70I, the flag “1” is set in the offset “10”, thereby indicating that the phoneme code string “s” “a” “i” “t” “o:” is present at the start corresponding to the word number “1”.

The word extracting unit 155 corrects a high-order bitmap 65 corresponding to the start and the phoneme code string “s” “a” “i” “t” “o:”. In the high-order bitmap 65, since the result of “1” is obtained from the AND operation of the bitmap 70H corresponding to the start and the phoneme code string “s” “a” “i” “t” and the bitmap 74 corresponding to the phoneme code “o:”, the flag “1” is set corresponding to the word number “1”.

The word extracting unit 155 repeatedly performs the abovementioned operations also with respect to the other word numbers corresponding to which the flag “1” is set in the initial high-order bitmap 60, and consequently generates (updates) the high-order bitmap 65 corresponding to the start and the phoneme code string “s” “a” “i” “t” “o”. That is, as a result of generating the high-order bitmap 65, it becomes possible to know about the words before which the start and the phoneme code string “s” “a” “i” “t” “o” is present . Thus, the word extracting unit 155 extracts the word candidates before which the start and the phoneme code string “s” “a” “i” “t” “o” is present.

Returning to the explanation with reference to FIG. 2, based on the word HMM data 143, the word estimating unit 156 estimates words from the extracted word candidates. Herein, the word HMM data 143 is generated by the word HMM generating unit 151. For example, based on the word HMM data 143, the word estimating unit 156 obtains the co-occurrence rates of the words co-occurring with each of a plurality of word candidates extracted by the word extracting unit 155. Then, according to the co-occurrence rate of each co-occurring word, the word estimating unit 156 calculates a score for the combination with each co-occurring word. Subsequently, the word estimating unit 156 performs maximum likelihood estimation of the words with the aim of adapting the combination having the highest score.

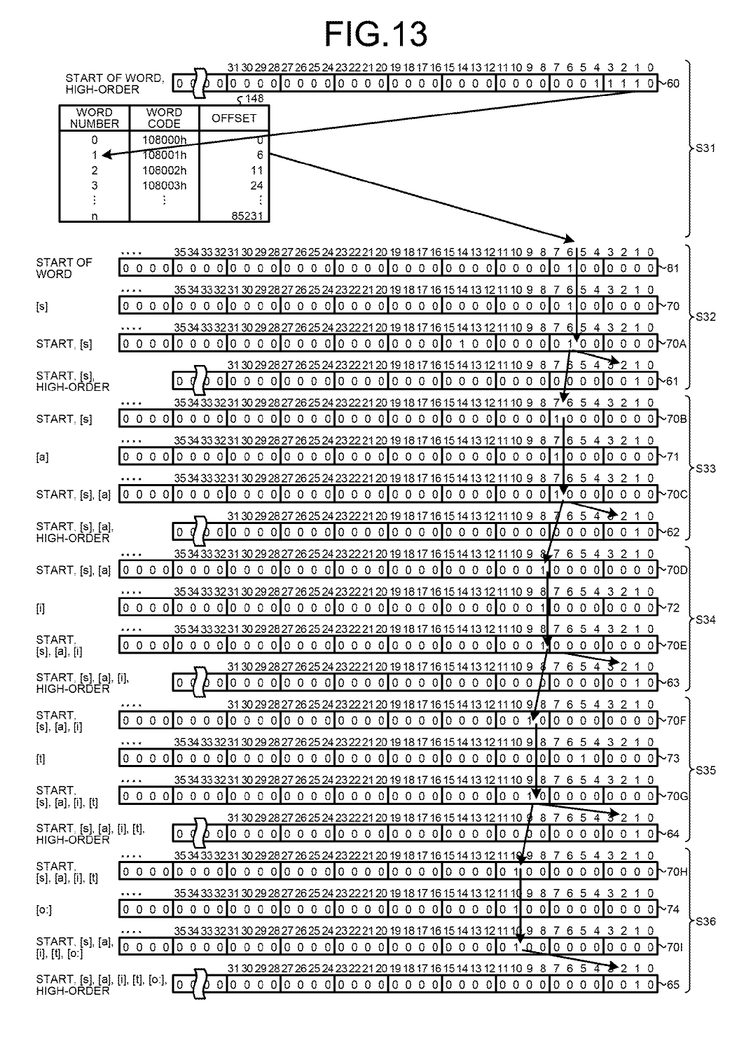

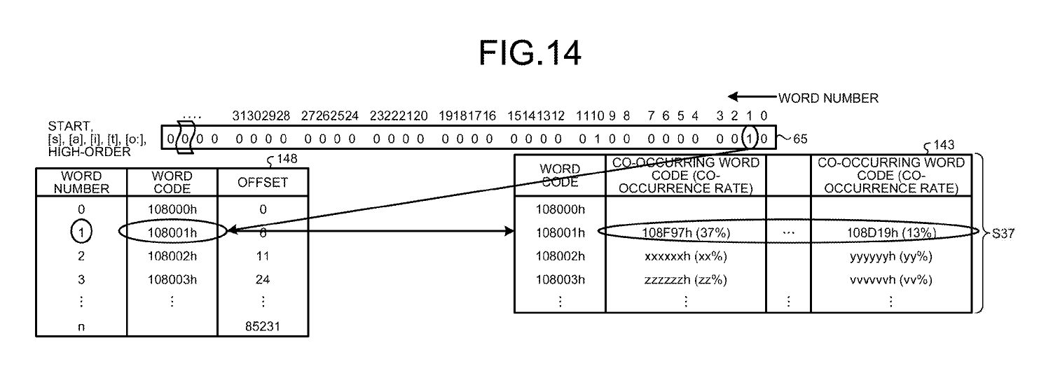

FIG. 14 is a diagram for explaining an example of the operation for estimating words. In the example illustrated in FIG. 14, it is assumed that the word extracting unit 155 generates the high-order bitmap 65 with corresponding to the start and the phoneme code string “s” “a” “i” “t” “o:” as illustrated at S36 in FIG. 13.

The following explanation is given about the operation performed at Step S37 illustrated in FIG. 14. The word estimating unit 156 identifies the word numbers corresponding to which “1” is set in the high-order bitmap 65 of the start and the phoneme code string “s” “a” “i” “t” “o:”. Herein, since the flag “1” is set corresponding to the word number “1”, it results in the identification of the word number “1”. Then, the word estimating unit 156 obtains, from the offset table 148, the word code corresponding to the identified word number. Herein, the word code “108001h” is obtained as the word code corresponding to the word number “1”. Then, the word estimating unit 156 extracts the word corresponding to the obtained word code from the dictionary data 142. That is, the word estimating unit 156 extracts the word “ [symbol] ” (written in kanji) corresponding to the phoneme notation included in the target phoneme notation data for searching.

Besides, the word estimating unit 156 refers to the word HMM data 143 and obtains co-occurrence information of other co-occurring words with respect to the obtained word code. The co-occurrence information contains, for example, the word codes and the co-occurrence rates of the co-occurring words. Thus, with respect to the obtained word code “108001h”, the word estimating unit 156 obtains the co-occurrence information (“108F97h”, (37%)), . . . , (“108D19h”, (13%)) of other co-occurring words.

Based on the co-occurrence information with respect to the obtained word code, the word estimating unit 156 calculates a score about the combination with each co-occurring word. For example, for each obtained word code, the word estimating unit 156 obtains the corresponding co-occurring word codes and the co-occurrence rates. Thus, for each obtained word code, the word estimating unit 156 calculates scores using the co-occurrence rates of the corresponding co-occurring word codes.

Then, with the aim of adapting the combination having the highest score, the word estimating unit 155 performs maximum likelihood estimation of the words indicated by the word codes corresponding to the combinations.

As a result, based on the word codes, the word extracting unit 155 can link the word HMMs and obtain the co-occurring words. As a result of linking the word HMMs and obtaining the co-occurring words; for example, the word extracting unit 155 can achieve enhancement in the accuracy of speech recognition. Moreover, the word extracting unit 155 can achieve standardization of the word HMMs for morphological analysis and speech recognition. Furthermore, as a result of using the word codes, the word extracting unit 155 can achieve reduction in the size of the word HMM data 143. Moreover, in the text analysis during morphological analysis or in the calculation of scores of the word HMMs during speech recognition, the word extracting unit 155 can achieve efficiency in accessing the word HMMs that are reliant on the word codes.

Given below is the explanation of an exemplary sequence of operations performed in the information processing device 100 according to the embodiment.

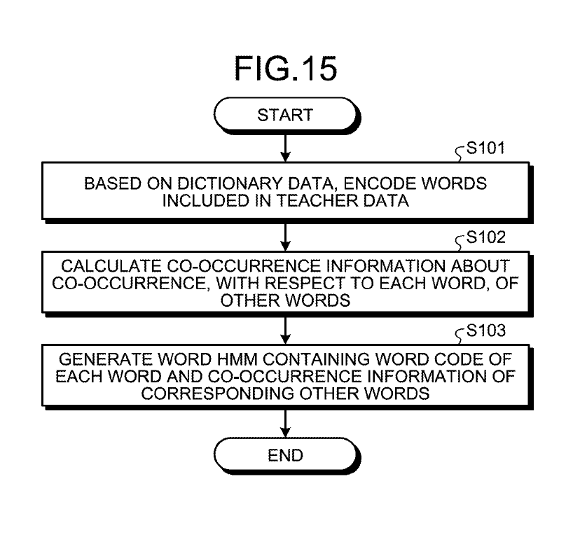

FIG. 15 is a flowchart for explaining a sequence of operations performed by the word HMM generating unit. As illustrated in FIG. 15, upon receiving the dictionary data 142 to be used in morphological analysis and upon receiving the teacher data 141, the word HMM generating unit 151 of the information processing device 100 encodes the words included in the teacher data 141 based on the dictionary data 142 (Step S101).

Then, the word HMM generating unit 151 calculates, for each word included in the teacher data 141, the co-occurrence information regarding the other words included in the teacher data 141 (Step S102).

Subsequently, the word HMM generating unit 151 generates the word HMM data 143 containing the word code of each word and the co-occurrence information of the corresponding other words (Step S103). That is, the word HMM generating unit 151 generates the word HMM data 143 containing the word code of each word and containing the word codes and the co-occurrence rates of the corresponding other words.

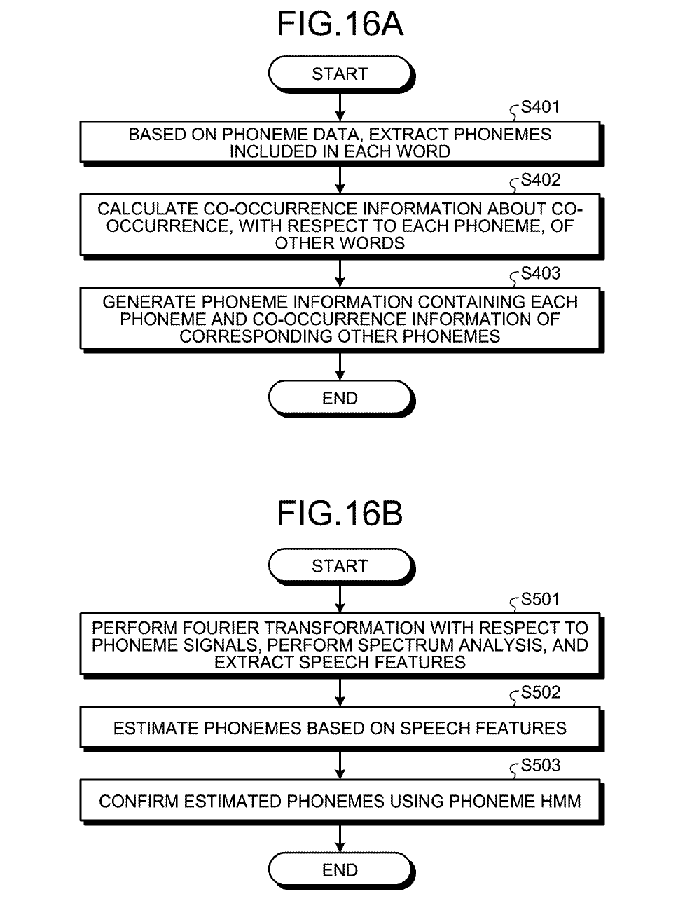

FIG. 16A is a flowchart for explaining a sequence of operations performed by the phoneme HMM generating unit. The phonemes considered in FIG. 16A correspond to phoneme codes. As illustrated in FIG. 16A, upon receiving the phoneme data, the phoneme HMM generating unit 152 of the information processing device 100 extracts the phonemes included in each word based on the phoneme data (Step S401).

Then, the phoneme HMM generating unit 152 calculates, with respect to each phone, the co-occurrence information of the other phonemes (Step S402).

Subsequently, the phoneme HMM generating unit 152 generates the phoneme HMM data 144 containing each phoneme and the co-occurrence information of the corresponding other phonemes (Step S403). That is, the phoneme HMM generating unit 152 generates the phoneme HMM data 144 containing each phoneme and containing the corresponding other phonemes and the respective co-occurrence rates.

FIG. 16B is a flowchart for explaining a sequence of operations performed by the phoneme estimating unit. The phonemes considered in FIG. 16B correspond to phoneme codes. As illustrated in FIG. 16B, upon receiving phoneme signals (phoneme data), the phoneme estimating unit 153 of the information processing device 100 performs Fourier transformation with respect to the phoneme data, performs spectrum analysis, and extracts the speech features (Step S501).

Then, the phoneme estimating unit 153 estimates the phonemes based on the extracted speech features (Step S502). Subsequently, the phoneme estimating unit 153 refers to the phoneme HMM data 144 and confirms the estimated phonemes (Step S503). That is done in order to achieve enhancement in the accuracy of the estimated phoneme codes.

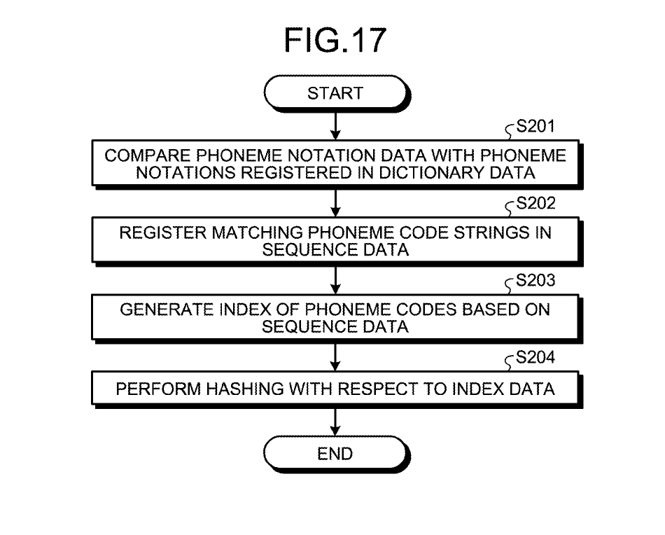

FIG. 17 is a flowchart for explaining a sequence of operations performed by the index generating unit. As illustrated in FIG. 17, the index generating unit 154 of the information processing device 100 compares the phoneme notation data 145 with the phoneme notations registered in the dictionary data 142 (Step S201).

The index generating unit 154 registers, in the sequence data 146, the phoneme code strings matching with the phoneme notation 142a registered in the dictionary data 142 (Step S202). Then, based on the sequence data 146, the index generating unit 154 generates the index 147′ of the phoneme codes (Step S203). Subsequently, the index generating unit 154 performs hashing with respect to the index 147′, and generates the index data 147 (Step S204).

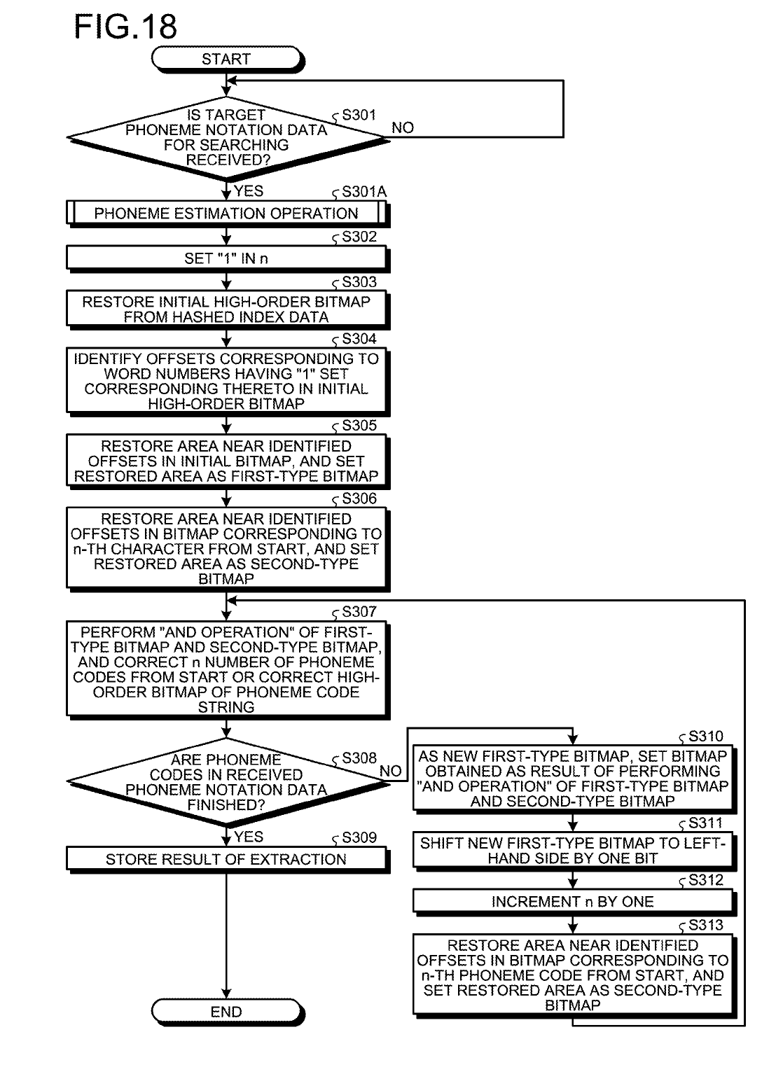

FIG. 18 is a flowchart for explaining a sequence of operations performed by the word extracting unit. As illustrated in FIG. 18, the word extracting unit 155 of the information processing device 100 determines whether or not the target phoneme notation data for searching is received (Step S301). If it is determined that the target phoneme notation data for searching is not received (No at Step S301), then the word extracting unit 155 repeatedly performs the determination until the target phoneme notation data for searching is received.

When it is determined that the target phoneme data for searching is received (Yes at Step S301), the word extracting unit 155 performs a phoneme estimation operation with respect to the phoneme notation data (Step S301A). Herein, the phoneme estimation operation represents the operation performed by the phoneme estimating unit as illustrated in FIG. 16B. After the phoneme estimation operation is performed, the word extracting unit 155 performs a word extraction operation with respect to the resultant phoneme code string in the following manner.

The word extracting unit 155 sets “1” in a temporary area n (Step S302). Herein, n represents the position of the phoneme code string from the start. Then, the word extracting unit 155 restores the initial high-order bitmap from the hashed index data 147 (Step S303).

The word extracting unit 155 refers to the offset table 148, and identifies the offsets corresponding to the word numbers having “1” set corresponding thereto in the initial high-order bitmap (Step S304). Then, the word extracting unit 155 restores the area near the identified offsets in the initial bitmap, and sets the restored area as a first-type bitmap (Step S305). Subsequently, the word extracting unit 155 restores the area near the identified offsets in the bitmap corresponding to the n-th character from the start of the target phoneme notation data for searching, and sets the restored area as a second-type bitmap (Step S306).

The word extracting unit 155 performs the AND operation of the first-type bitmap and the second-type bitmap, and corrects the n number of phoneme codes from the start of the target phoneme notation data for searching, or corrects the high-order bitmap of the phoneme code string (Step S307). For example, if the result of the AND operation is “0”, then the word extracting unit 155 sets the flag “0” in the n number of phoneme codes from the start of the target phoneme notation data for searching or sets the flag “0” at the positions corresponding to the word numbers in the high-order bitmap of the phoneme code string, and corrects the high-order bitmap. On the other hand, if the result of the AND operation is “1”, then the word extracting unit 155 sets the flag “1” in the n number of phoneme codes from the start of the target phoneme notation data for searching or sets the flag “1” at the positions corresponding to the word numbers in the high-order bitmap of the phoneme code string, and corrects the high-order bitmap.

Then, the word extracting unit 155 determines whether or not the phoneme codes in the received phoneme notation data are finished (Step S308). If it is determined that the phoneme codes in the received phoneme notation data are finished (Yes at Step S308), then the word extracting unit 155 stores the extraction result in the memory unit 140 (Step S309), and ends the word extraction operation. On the other hand, if the phoneme codes in the received phoneme notation data are not yet finished (No at Step S308), then the word extracting unit 155 sets, as the new first-type bitmap, the bitmap obtained as a result of performing the AND operation of the first-type bitmap and the second-type bitmap (Step S310).

Subsequently, the word extracting unit 155 shifts the first-type bitmap to the left-hand side by one bit (Step S311). Moreover, the word extracting unit 155 increments the temporary area n by one (Step S312). Then, the word extracting unit 155 restores the area near the identified offsets in the bitmap corresponding to the n-th phoneme code from the start of the target phoneme notation data for searching, and sets the restored area as the new second-type bitmap (Step S313). Then, the system control returns to Step S307, and the word extracting unit 155 performs the AND operation of the first-type bitmap and the second-type bitmap.

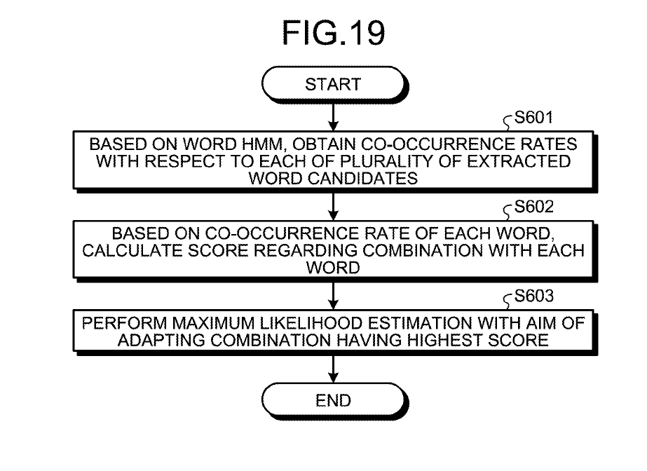

FIG. 19 is a flowchart for explaining a sequence of operations performed by the word estimating unit. Herein, it is assumed that, for example, the n number of phoneme codes from the start are stored or the high-order bitmap of the phoneme code string is stored as the result of extraction performed by the word extracting unit 155.

As illustrated in FIG. 19, based on the word HMM data 143, the word estimating unit 156 of the information processing device 100 obtains, with respect to each of a plurality of word candidates included in the result of extraction performed by the word extracting unit 155, the co-occurrence rates of the other co-occurring words (Step S601). For example, the word estimating unit 156 identifies, from the n number of phoneme codes from the start or from the high-order bitmap of the phoneme code string, the word codes corresponding to the word numbers having “1” set corresponding thereto. Then, the word estimating unit 156 refers to the word HMM data 143 and obtains the co-occurrence rates of the other co-occurring words with respect to each of the identified word code. The co-occurrence information contains, for example, the word codes and the co-occurrence rates of the co-occurring words.

Based on the co-occurrence rates of the co-occurring words with respect to each of a plurality of word candidates, the word estimating unit 156 calculates a score regarding the combination with each co-occurring word (Step S602).

Then, the word estimating unit 156 performs maximum likelihood estimation of the words with the aim of adapting the combination having the highest score (Step S603). Subsequently, the word estimating unit 156 outputs the estimated words.

### EFFECT OF EMBODIMENT

Given below is the explanation of the effect achieved in the information processing device 100 according to the embodiment. The information processing device 100 receives the dictionary data 142 that is used in common in speech recognition and morphological analysis, and receives the teacher data 141. Based on the dictionary data 142 and the teacher data 141, the information processing device 100 generates the word HMM data 143 containing the word codes that enable identification of the words registered in the dictionary data 142 and the co-occurrence information about co-occurrence, with respect to each word, of the words included in the text data. With such a configuration, in the information processing device 100, the dictionary data 142 can be standardized for speech recognition and morphological analysis, and the speech-recognizable word candidates can be efficiently extracted. That is, in the information processing device 100, as a result of using the dictionary data 142 and the word HMM data 143, the extraction and maximum likelihood estimation of the words can be performed with efficiency. For example, in the information processing device 100, since the co-occurrence information is generated for each word code, words representing conversion candidates are extracted from the word candidates, which are identified by the word codes, according to the co-occurrence state of the other words identified by the word codes; and thus the cost of word extraction can be reduced. That is, in the information processing device 100, during speech recognition, it becomes possible to reduce the cost of extracting the words representing the conversion candidates. Moreover, a conventional word HMM is configured with variable-length character strings and thus has a large size. In contrast, the word HMM data 143 is configured with word codes instead of variable-length character strings. Hence, it becomes possible to achieve reduction in size.

Moreover, the information processing device 100 further receives first-type phoneme notation data. Then, the information processing device 100 generates the phoneme HMM data 144 that contains the phoneme codes included in the first-type phoneme notation data, and contains the co-occurrence information about co-occurrence, with respect to each phoneme code, of the other phoneme codes included in the phoneme notation data. With such a configuration, as a result of using the phoneme HMM data 144 in the information processing device 100, it becomes possible to enhance the accuracy of the phoneme codes estimated from the phoneme notation data.

Furthermore, the information processing device 100 further receives second-type phoneme notation data. Then, the information processing device 100 refers to the word HMM data 143 and estimates the phoneme code strings included in the second-type phoneme notation data. Based on the index data 147 that indicates the relative positions of the phoneme codes including the phoneme codes included in the phoneme notation of each word registered in the dictionary data 142, the initial phoneme code of the phoneme notation, and the last phoneme code of the phoneme notation; the information processing device 100 identifies, from among the phoneme notations of the words registered in the dictionary data 142, the phoneme notations included in the estimated phoneme code string. Then, the information processing device 100 identifies the words corresponding to the identified phoneme notations. Subsequently, the information processing device 100 refers to the generated word HMM data 143 and, using the word codes of the identified words, extracts one of the identified words. With such a configuration, in the information processing device 100, as a result of using the index data 147 and the word HMM data 143, the extraction and maximum likelihood estimation of the words related to speech recognition can be performed with efficiency.

Moreover, the information processing device 100 receives the dictionary data 142 that is used in common in speech recognition and morphological analysis. Based on the received dictionary data 142, the information processing device 100 generates the index data 147 that indicates the relative positions of the phoneme codes including the phoneme codes included in the phoneme notation of each word registered in the dictionary data 142, the initial phoneme code of the phoneme notation, and the last phoneme code of the phoneme notation. With such a configuration, in the information processing device 100, the dictionary data 142 can be standardized for speech recognition and morphological analysis, and the extraction and maximum likelihood estimation of the words can be performed with efficiency using the index data 147 that is generated based on the dictionary data 142.

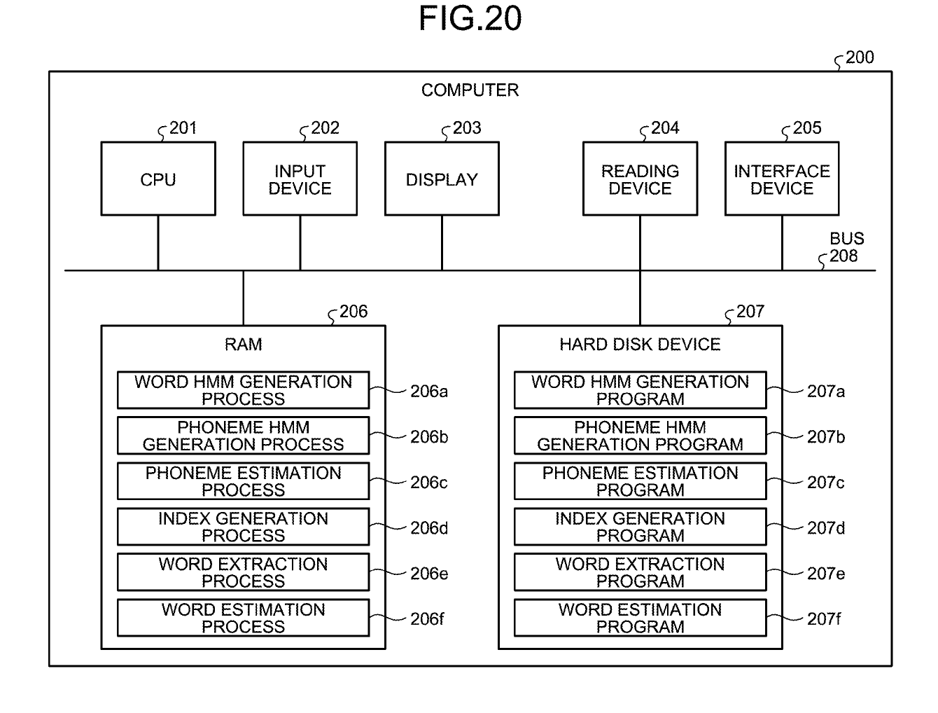

Given below is the explanation of an exemplary hardware configuration of a computer that implements the identical functions to the information processing device 100 according to the embodiment described above. FIG. 20 is a diagram illustrating an exemplary hardware configuration of a computer that implements the identical functions to the information processing device.

As illustrated in FIG. 20, a computer 200 includes a central processing unit (CPU) 201 that performs various arithmetic operations; an input device 202 that receives input of data from the user; and a display 203. Moreover, the computer 200 includes a reading device 204 that reads computer programs from a memory medium; and an interface device 205 that communicates data with other computers via a wired network or a wireless network. Furthermore, the computer 200 includes a random access memory (RAM) 206 that is used to temporarily store a variety of information; and a hard disk drive 207. Moreover, the devices 201 to 207 are connected to each other by a bus 208.

The hard disk device 207 includes a word HMM generation program 207a, a phoneme HMM generation program 207b, a phoneme estimation program 207c, an index generation program 207d, a word extraction program 207e, and a word estimation program 207f. The CPU 201 reads the computer programs and loads them in the RAM 206.

The word HMM generation program 207a functions as a word HMM generation process 206a. The phoneme HMM generation program 207b functions as a phoneme HMM generation process 206b. The phoneme estimation program 207c functions as a phoneme estimation process 206c. The index generation program 207d functions as an index generation process 206d. The word extraction program 207e functions as a word extraction process 206e. The word estimation program 207f functions as a word estimation process 206f.

The operations performed in the word HMM generation process 206a correspond to the operations performed by the word HMM generating unit 151. The operations performed in the phoneme HMM generation process 206b correspond to the operations performed by the phoneme HMM generating unit 152. The operations performed in the phoneme estimation process 206c correspond to the operations performed by the phoneme estimating unit 153. The operations performed in the index generation process 206d correspond to the operations performed by the index generating unit 154. The operations performed in the word extraction process 206e correspond to the operations performed by the word extracting unit 155. The operations performed in the word estimation process 206f correspond to the operations performed by the word estimating unit 156.

Meanwhile, the computer programs 207a to 207f need not always be stored in the hard disk device 207. Alternatively, the computer programs 207a to 207f can be stored in a “portable physical medium” such as a flexible disc (FD), a compact disc read only memory (CD-ROM), a digital versatile disc (DVD), a magneto-optical disc, or an IC card. Then, the computer 200 can read the computer programs 207a to 207f and execute them.

As an aspect, it becomes possible to achieve standardization of the word dictionary for speech recognition and the word dictionary for morphological analysis, and to perform extraction and maximum likelihood estimation of words with efficiency.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information generation method to be executed by a computer, the method comprising:
receiving dictionary data, which is to be used in common in speech analysis and morphological analysis, and text data using a processor; and
generating, based on the dictionary data and the text data, co-occurring word information that contains
word information enabling identification of each word registered in the dictionary data, and
co-occurrence information about co-occurrence, with respect to the each word, of words included in the text data using the processor.

2. The method according to claim 1, wherein the method further comprising
receiving first-type phoneme notation data, and
generating co-occurring phoneme information that contains
each phoneme code included in the first-type phoneme notation data, and
co-occurrence information about co-occurrence, with respect to the each phoneme code, of other phoneme codes included in the first-type phoneme notation data.

3. The method according to claim 2, wherein the method further comprising
receiving second-type phoneme notation data,
estimating that includes referring to the co-occurring phoneme information and estimating phoneme code string included in the second-type phoneme notation data,
identifying that includes
identifying, based on index information that indicates relative position of each phoneme code including phoneme codes included in phoneme notation of each word registered in the dictionary data, initial phoneme code of the phoneme notation, and last phoneme code of the phoneme notation, phoneme notations included in the estimated phoneme code string from among phoneme notations of words registered in the dictionary data, and
identifying words corresponding to the identified phoneme notations, and
extracting that includes referring to the generated co-occurring word information and extracting one of the identified words according to word information of the identified words.

4. An information processing device comprising:
a processor;
a memory, wherein the processor executes a process comprising:
first generating, based on text data and dictionary data to be used in common in speech analysis and morphological analysis, co-occurring word information that contains
word information enabling identification of each word registered in the dictionary data, and
co-occurrence information about co-occurrence, with respect to the each word, of words included in the text data;
second generating, based on the dictionary data, index information that indicates
relative position of each phoneme code including phoneme codes included in phoneme notation of each word registered in the dictionary data, initial phoneme code of the phoneme notation, and last phoneme code of the phoneme notation;
identifying, based on the index information generated at the second generating, phoneme notations included in received phoneme notation data from among phoneme notations of words registered in the dictionary data, and identifying words corresponding to the identified phoneme notations; and
extracting that includes referring to the co-occurring word information generated at the first generating, and extracting one of the identified words according to word information of the words identified at the identifying.

5. A word extraction method to be executed by a computer, the method comprising:
receiving phoneme notation data using a processor;
identifying that includes
identifying, based on index information that indicates relative position of each phoneme code including using the processor
phoneme codes included in phoneme notation of each word registered in dictionary data that is to be used in common in speech analysis and morphological analysis,
initial phoneme code of the phoneme notation, and
last phoneme code of the phoneme notation,
phoneme notations included in the received phoneme notation data from among phoneme notations of words registered in the dictionary data, and
identifying words corresponding to the identified phoneme notations using the processor; and
extracting, based on the dictionary data and text data, that includes
referring to co-occurring word information that contains
word information enabling identification of each word registered in the dictionary data, and
co-occurrence information about co-occurrence, with respect to the each word, of words included in the text data, and
extracting one of the identified words according to word information of the identified words using the processor.
